(19) United States
(12) Patent Application Publication
(10) Pub. No.: US 2004/0076101 A1
(43) Pub. Date: Apr. 22, 2004

(54) High-density read-only optical disc, method for recording disc information (DI) on the high-density read-only optica disc, and method for reproducing data recorded on the high-density read-only optical disc

(76) Inventors: Sang Woon Suh, Seoul (KR); Won Bae Joo, Seoul (KR)

Correspondence Address: HARNESS, DICKEY & PIERCE, P.L.C., P.O. BOX 8910, RESTON, VA, 20195, US

(21) Appl. No.: 10/641,020

(22) Filed: Aug. 15, 2003

(30) Foreign Application Priority Data
Aug. 17, 2002 (KR) 10-2002-0048746
Sep. 11, 2002 (KR) 10-2002-0055100

(51) Int. Cl. G11B 7/0045; G11B 7/24

(52) U.S. Cl. 369/59.25; 369/275.3; 369/47.54

(57) ABSTRACT

A high-density read-only optical disc, a method for recording DI (Disc Information) on the high-density read-only optical disc, and a method for reproducing data recorded on the high-density read-only optical disc. The DI recording method for repeatedly recording pit-shaped DI appropriate for the high-density read-only optical disc in a specific recording area contained in a Lead-In or Lead-Out zone more than a predetermined number of times. Therefore, it quickly reads DI recorded in a specific recording area, and normally reproduces data based upon the read DI.

### BACKGROUND OF THE INVENTION

1. Field of the Invention

The present invention relates to a method for recording information on a high-density read-only optical disc, and more particularly to a high-density read-only optical disc, a method for recording disc information on the high-density read-only optical disc such as a BD-ROM (Blu-ray Disc Read Only Memory), and a method for reproducing data recorded on the high-density read-only optical disc.

2. Description of the Related Art

In recent times, there has been newly developed a high-density optical disc capable of storing large amounts of high-quality video data and high-quality audio data, for example, a BD-RE (Blu-ray Disc Rewritable). Referring to FIG. 1, the BD-RE 100 is comprised of a clamping area, a transition area, a BCA (Burst Cutting Area), a Lead-In zone, a data zone, a Lead-Out Zone, etc. Data is recorded on the BD-RE 100 while being classified in RUB (Recording Unit Blocks) units each having the same length as one ECC (Error Correction Code) block unit, as shown in FIG. 2.

The Lead-In zone of the BD-RE 100 is classified into a pre-recorded part and a rewritable part, as shown in FIG. 2. The PIC (Permanent Information & Control data) zone is assigned to the pre-recorded part, and first and second DMAs (Defect Management Areas) for recording necessary defect management information needed to substitute for a defective block detected during a data recording time are assigned to the rewritable part.

The Lead-Out zone of the BD-RE 100 serves as a rewritable part. Third and fourth DMAs for recording recording defect management information are assigned the Lead-Out zone as shown in FIG. 3.

FIG. 4 depicts a table composed of disc information (DI) repeatedly recorded in the PIC zone of the BD-RE. DI (Disc Information) to be permanently recorded, for example, essential DI such as DT (Disc Type) information and DZA (Data Zone Allocation) information is converted into wobble-shaped HFM (High Frequency Modulation) information, and the wobble-shaped HFM information is repeatedly recorded 5 times in the PIC zone. In this case, the DI contains a length of 112 bytes other than parity information 32 bytes long.

The reason why the DI is repeatedly recorded is to stably record or reproduce desired data by means of a stable detection of the DI. For example, provided that the DI is recorded in the PIC zone only once and is wrongly detected due to an unexpected error created at the DI's recording position, data of the BD-RE is not accurately recorded or reproduced.

The rewritable Lead-In, data, and Lead-Out zones contain wobble-shaped grooves (i.e., wobbled grooves), such that data to be recorded in these zones is aligned and recorded in the wobble-shaped grooves. ADIP (Address In Pre-groove) information composed of an ADIP address and AUX data is modulated in the wobbled grooves. The ADIP address contains physical ADIP address information in all the zones containing such wobbled grooves, i.e., the rewritable Lead-In, Data, and Lead-out zones. However, the AUX data contains DI in only the Lead-In zone other than the pre-recorded part. The data zone and the Lead-Out zone contain AUX data of zero, respectively. The essential DI such as DT and DZA information is recorded as AUX data in ADIP information modulated in the wobbled grooves formed in the rewritable Lead-In zone other than the PIC zone. In this case, the DI has a length of 144 bytes containing parity information 32 bytes long, and is repeatedly recorded in the wobbled grooves formed in the rewritable Lead-In zone.

A maximum of 11,270 DI blocks can be repeatedly recorded in the wobbled grooves of the Lead-In zone.

If the BD-RE 100 is loaded in an optical disc recorder, the optical disc recorder reads either HFM-wobbled DI contained in a PIC zone of the Lead-In zone or wobbled DI contained in the other Lead-In zone other than the PIC zone to recognize optical DT (Disc Type) information and DZA information, and normally records or reproduces data corresponding to the recognized DI.

Typically, DI is repeatedly recorded about 5 times in the PIC zone of the BD-RE, and the DI is repeatedly recorded in the ADIP information a predetermined number of times.

Recently, there has been newly developed a high-density read-only optical disc such as a BD-ROM, and many developers have conducted intensive research into the high-density read-only optical disc and its standardization. However, because a disc track structure of the high-density read-only optical disc may not be configured in the form of wobbled groves, DI in the form of wobble grooves as in the ADIP information or PIC zone of BD-RE cannot be recorded on the optical disc if the disc track structure is configured in the form of straight pits, such that there must be newly developed an effective DI recording method for solving the aforementioned problem.

### SUMMARY OF THE INVENTION

Therefore, the present invention has been made in view of the above problems, and it is an object of the present invention to provide a high-density read-only optical disc such as a BD-ROM, an effective DI recording method for repeatedly recording the pit-shaped DI appropriate for the high-density read-only optical disc in a specific recording area contained in a Lead-In or Lead-Out zone more than a predetermined number of times in order to normally reproduce data recorded on the high-density read-only optical disc, and a method for reproducing data recorded on the high-density read-only optical disc.

In accordance with one aspect of the present invention, the above and other objects can be accomplished by the provision of a method for recording information on a high-density read-only optical disc, comprising the step of: repeatedly recording pit-shaped DI (Disc Information) associated with the high-density read-only optical disc in either a Lead-In zone or a Lead-Out zone.

In accordance with another aspect of the present invention, there is provided a high-density recording medium, comprising: a Lead-In zone or a Lead-Out zone, wherein data is recorded in a recording unit, and DI (Disc Information) in the form of pits, containing at least one of DT (Disc Type) information and DZA (Data Zone Allocation) information, is repeatedly recorded in the Lead-In zone or the Lead-Out zone.

In accordance with yet another aspect of the present invention, there is provided a method for reproducing data recorded on a high-density read-only optical disc, comprising the steps of: a) reading pit-shaped DI (Disc information) recorded on a Lead-In zone or a Lead-Out zone of the high-density read-only optical disc, while the DI including information required for reproducing data recorded on the high-density read-only optical disc; and b) reproducing the data recorded on the high-density read-only optical disc based upon the read DI.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows an internal structure of a BD-RE;

FIG. 2 is a table illustrating information recorded in a Lead-In zone of the BD-RE;

FIG. 3 is a table illustrating information recorded in a Lead-Out zone of the BD-RE;

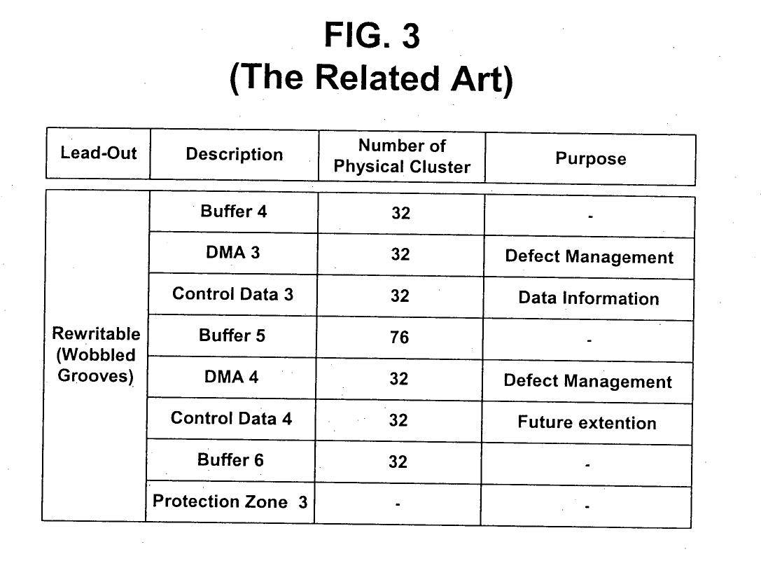

FIG. 4 is a table illustrating disc information repeatedly recorded in a PIC zone of the BD-RE;

FIG. 5 is a table illustrating DI repeatedly recorded in either the Lead-In zone or the Lead-Out zone of the BD-ROM in accordance with the present invention;

FIG. 6 is a table illustrating a detailed configuration of the DI repeatedly recorded in either the Lead-In zone or the Lead-Out zone of the BD-ROM in accordance with the present invention;

FIG. 7 shows an internal configuration of an exemplary DI sector defined by the inventive DI recording method in accordance with the present invention;

FIG. 8 shows an internal configuration of an exemplary physical cluster containing the DI sector in accordance with the present invention; and

FIG. 9 is a block diagram of an optical disc player for reproducing data recorded on the BD-ROM in accordance with the present invention.

### DETAILED DESCRIPTION OF PREFFERRED EMBODIMENTS

Now, preferred embodiments of the present invention will be described in detail with reference to the annexed drawings.

A high-density read-only optical disc, a method for recording DI on the high-density read-only optical disc, and a method for reproducing data recorded on the high-density read-only optical disc will hereinafter be described in detail.

The method for recording DI on the high-density read-only optical disc can be applicable to a method for manufacturing a BD-ROM.

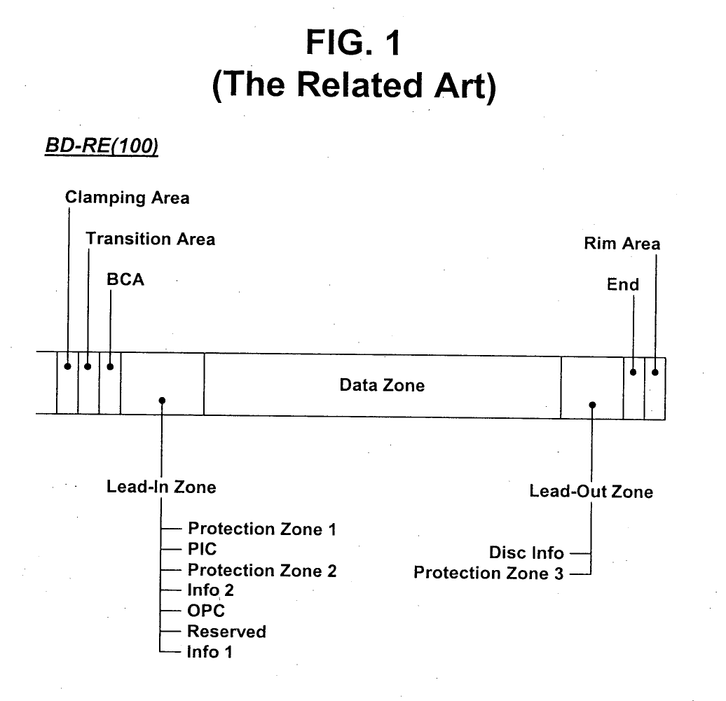

The BD-ROM is comprised of a clamping area, a transition area, a BCA (Burst Cutting Area), a Lead-In zone, a data zone, and a Lead-Out zone, etc., as shown in FIG. 1. Data is recorded on the BD-ROM while being classified in RUB (Recording Unit Block) units each having the same length as one ECC block unit.

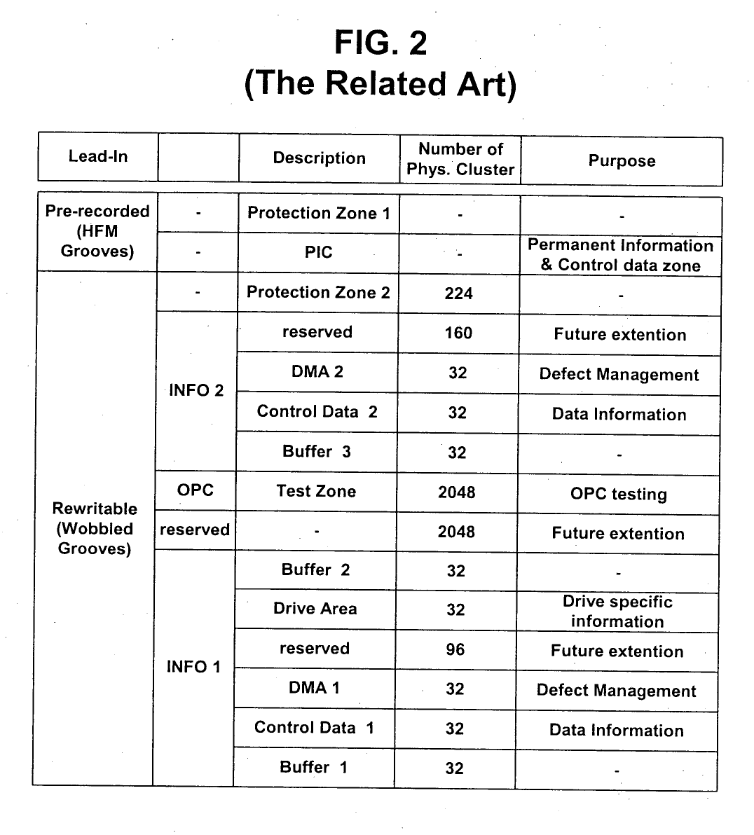

Pit-shaped DI is recorded in the Lead-in and Lead-Out zones. A specific recording area contained in the Lead-In zone of the BD-ROM corresponds to the first DMA “DMA 1” of the BD-RE shown in FIG. 2. A DI block 144 bytes long composed of both DI 112 bytes long and parity information 32 bytes long is repeatedly recorded in the specific recording area of the Lead-In zone of the BD-ROM.

For example, the specific recording area corresponding to the first DMA “DMA 1” is composed of 32 physical clusters having a predetermined length (i.e., 498 rows×1932 channel bits), such that the DI block 144 bytes long can be repeatedly recorded about 14563 times in the specific recording area.

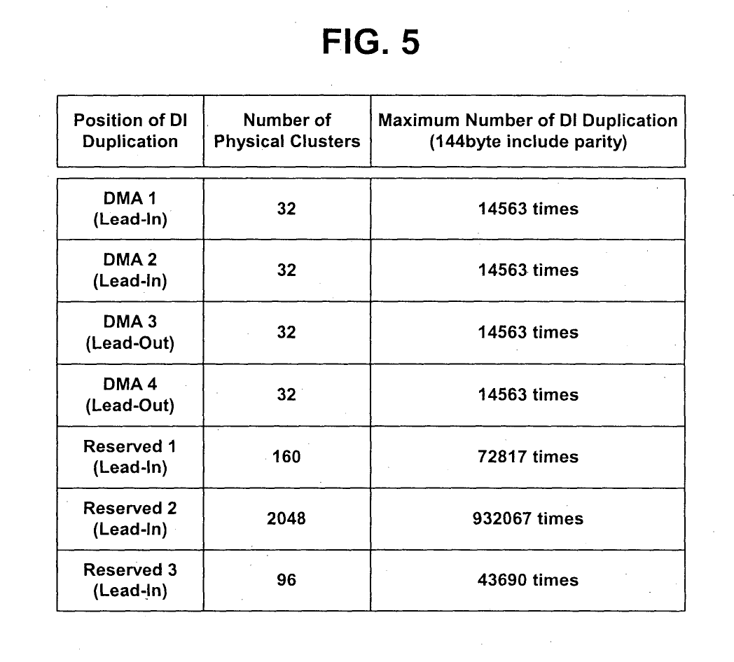

According to another preferred embodiment of the present invention, the DI block 144 bytes long created by the sum of DI 112 bytes long and parity information 32 bytes long can also be repeatedly recorded in a second specific recording area corresponding to the second DMA “DMA 2” of the BD-RE 100 about 14563 times, as shown in FIG. 5. In this case, the second specific recording area is contained in the Lead-In zone of the BD-ROM.

The DI block 144 bytes long created by the sum of DI 112 bytes long and parity information 32 bytes long can also be repeatedly recorded in a third specific recording area or a fourth specific recording area corresponding to either a third DMA “DMA 3” or a fourth DMA “DMA 4” of the BD-RE 100 about 14563 times. In this case, the third specific recording area or the Fourth specific recording area is also contained in the Lead-Out zone of the BD-ROM.

According to yet another preferred embodiment of the present invention, a DI block 144 bytes long created by the sum of DI 112 bytes long and parity information 32 bytes long can be repeatedly recorded in a specific recording area, corresponding to a first reserved area “Reserved 1” of the BD-RE 100, contained in the Lead-In zone of the BD-ROM more than a predetermined number of times. The first reserved zone “Reserved 1” is composed of 160 physical clusters, such that the DI block 144 bytes long can be repeatedly recorded about 72817 times in the specific recording area corresponding to the first reserved zone.

Further, the DI block 144 bytes long can also be recorded in a specific recording area corresponding to either a second reserved zone “Reserved 2” or a third reserved zone “Reserved 3” contained in the Lead-In zone of the BD-ROM more than a predetermined number of times. For example, the second reserved zone “Reserved 2” is composed of 2048 physical clusters, such that the DI block 144 bytes long can be repeatedly recorded about 932067 times in the specific recording area corresponding to the second reserved zone “Reserved 2”. And the third reserved zone “Reserved 3” is composed of 96 physical clusters, such that the DI block 144 bytes long can be repeatedly recorded about 43690 times in the specific recording area corresponding to in the third reserved zone “Reserved 3”.

Although the aforementioned preferred embodiments disclose methods for repeatedly recording the DI block 144 bytes long containing parity information 32 bytes long, it should be noted that only the DI frame 112 bytes long other than the parity information 32 bytes long can be repeatedly recorded in the above zones. Provided that only the DI frame 112 bytes long is recorded therein, the DI frame can be repeatedly recorded much more than the repeating recording times of the DI block having all of the parity information and the DI.

Furthermore, all information contained in the PIC zone having the DI block may also be repeatedly recorded.

In the case of a multi-layered BD-ROM, particularly, in the case of a dual-layered BD-ROM, all information contained in one of the above DI block, DI frame, and the PIC zone may be repeatedly recorded at the same position of individual layers.

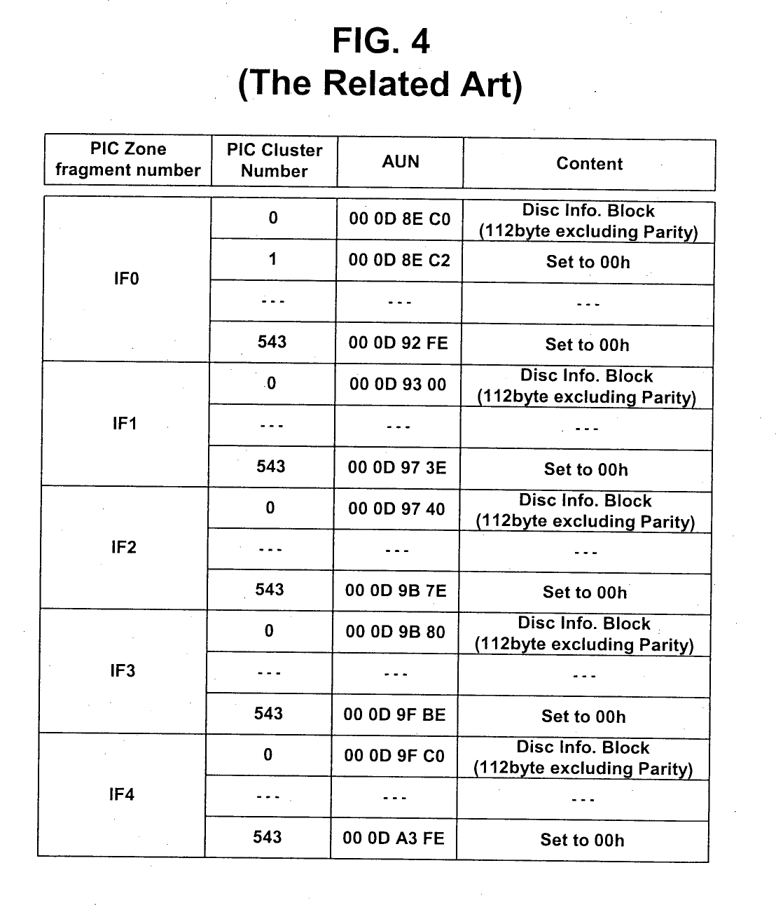

As previously stated in FIG. 4, HFM-wobbled DI (Disc Information) is repeatedly recorded in the PIC zone of the BD-RE 100 5 times, DI is modulated in wobbled grooves formed in the rewritable Lead-in zone other than the PIC zone of the BD-RE 100, and at the same time is repeatedly recorded in the wobbled grooves or the BD-RE 100. But the DI in the form of pits can be repeatedly recorded in a specific recording area of the Lead-In zone or the Lead-Out zone of the BD-ROM.

In the meantime, although all information contained in the DI block, the DI frame, or the PIC zone is repeatedly recorded in a following zone next to the PIC zone of either the Lead-In zone or the Lead-Out zone in the above preferred embodiment, it should be noted that such information may be repeatedly recorded in a first protection zone “Protection Zone 1” shown in FIG. 2 and/or a zone other than the Lead-In or Lead-Out zone, for example, a BCA (Burst Cutting Area) shown in FIG. 1.

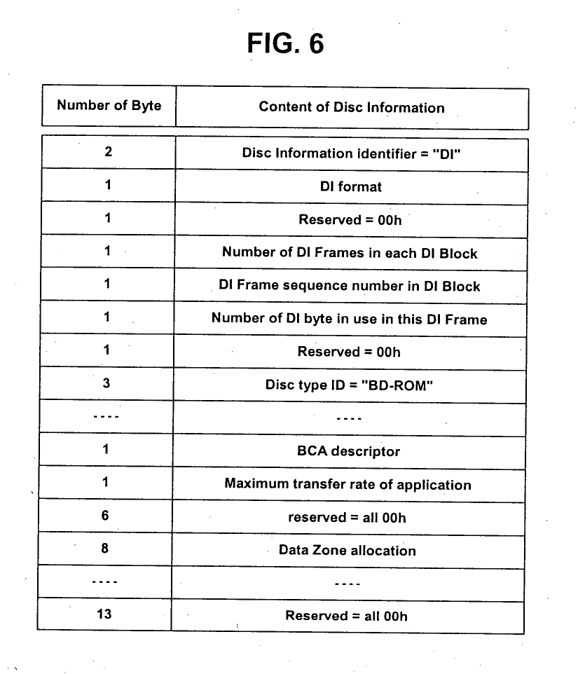

Pit-shaped DI repeatedly recorded in a specific recording area of either the Lead-In zone or the Lead-Out zone of the BD-ROM contains only management information needed to reproduce data of the BD-ROM. For example, as shown in FIG. 6, the management information includes “DI” information for representing the characters “DI”, DI format information “DI format” for identifying a DI according to this version, “Number of DI Frames in each DI Block” information for specifying the number of DI Frames in each DI Block, “DI Frame sequence number in DI Block” information for specifying the sequential DI Frame number within the DI Block, “Number of DI bytes in use in this DI Frame” information for indicating the number of bytes in use in the actual DI Frame, “Disc Type ID” information for representing a BD-ROM disc type, “BCA descriptor” information for indicating the presence of a BCA-code on this disc, “Maximum transfer rate of application” information for specifying the maximum read transfer rate needed by the application, and “Data Zone allocation” information for specifying the first Physical ADIP Address of the data zone of a related layer, etc.

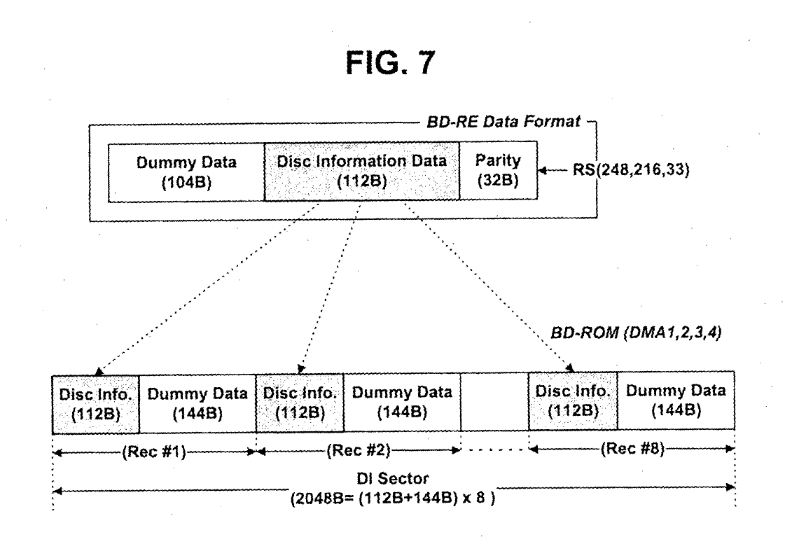

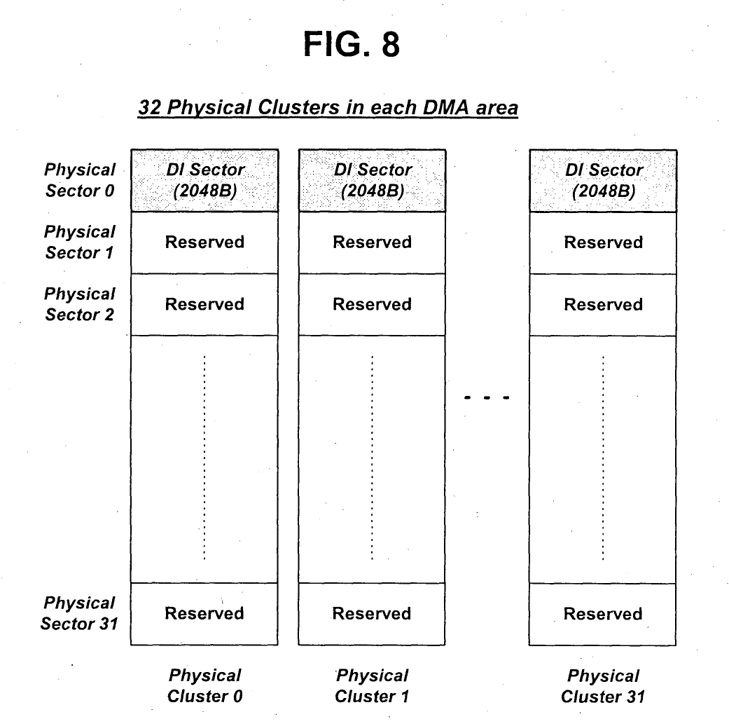

A method for recording pit-shaped DI in a specific recording area corresponding to a BD-RE's DMA contained in the Lead-In or Lead-Out zone of the BD-ROM will hereinafter be described with reference to FIGS. 7 and 8.

FIG. 7 shows an internal configuration of an exemplary DI sector defined by the inventive DI recording method in accordance with the present invention.

The BD-RE shown in FIG. 7 includes parity information 32 bytes long added to DI 112 bytes long, and adds dummy data 104 bytes long to adjust the length of an ECC (Error Correction Code), such that data 248 bytes long is recorded in the BD-RE.

The DI recording method according to the present invention repeatedly records data 256 bytes long in a physical sector 2048 bytes long 8 times. In this case, the data 256 bytes long is created by the sum of DI 112 bytes long and dummy data 144 bytes long. Thereafter, the physical sector 2048 bytes long is newly defined as a DI sector.

The DI sector can be repeatedly recorded in a BD-ROM's specific recording area corresponding to the first or second DMA (i.e., “DMA 1” or “DMA 2”) contained in the Lead-In zone of the BD-RE, or the third or fourth DMA (i.e., “DMA 3” or “DMA 4”) contained in the Lead-Out zone of the BD-RE. In this case, as shown in FIG. 8, the DI sector is recorded in each first sector of 32 physical clusters “Physical Cluster 0˜Physical Cluster 31” contained in a predetermined recording zone corresponding to each DMA.

In more detail, in the physical cluster composed of 32 physical sectors each having the length of 2048 bytes, the DI sector is recorded in a first physical sector from among 32 physical sectors, and then 31 physical sectors other than the first physical sector are recorded as reserved sectors. An LDC (Long Distance Code) scheme used in a typical data recording process can be easily applied to the 32 physical clusters.

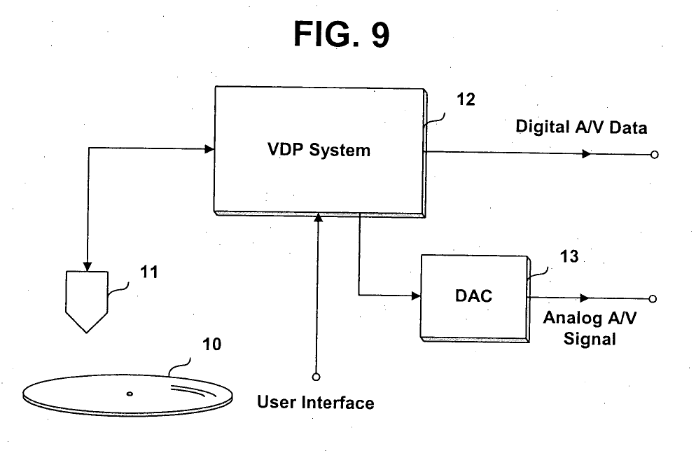

FIG. 9 is a block diagram of an optical disc player for reproducing data recorded on the BD-ROM in accordance with the present invention. The optical disc player shown in FIG. 9 is comprised of an optical pickup unit 11, a VDP (Video Disc Player) system 12, and a DAC (Digital-to-Analog Converter) 13.

If a BD_ROM is loaded in the optical disc player, the VDP system 12 searches for either one of a specific recording area of the Lead-in zone of the BD-ROM (i.e., a specific recording area corresponding to a DMA of the Lead-In zone of the BD-RE), a specific recording area corresponding to a reserved zone of the Lead-In zone, and a BCA zone.

Then, the VDP system 12 reads pit-shaped DI repeatedly recorded in the specific recording area from the DI sector, recognizes the principal DI such as DT (Disc Type) information, and thereby normally reproduces data based upon the recognized DI.

As apparent from the above description, the present invention provides a high-density read-only optical disc, a method for recording DI on the high-density read-only optical disc, and a method for reproducing data recorded on the high-density read-only optical disc. Therefore, it quickly reads DI recorded in a specific recording zone of the high-density read-only optical disc, and normally reproduces data based upon the read DI.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for recording information on a high-density read-only optical disc, comprising the step of:
repeatedly recording pit-shaped DI (Disc Information) associated with the high-density read-only optical disc in either a Lead-In zone or a Lead-Out zone.

2. The method as set forth in claim 1, wherein the Lead-In zone or the Lead-Out zone is comprised of a first area containing the DI and a second area separated from the first area,
wherein the second area also contains the repeatedly recorded DI.

3. The method as set forth in claim 1, wherein the DI is repeatedly recorded in a recording area corresponding to a DMA (Defect Management Area) of a BD-RE (Blu-ray Disc Rewritable).

4. The method as set forth in claim 3, wherein the DI is repeatedly recorded in physical sector units each having a predetermined length.

5. The method as set forth in claim 4, wherein the DI is contained in a DI sector having a predetermined length, and is then recorded.

6. The method as set forth in claim 5, wherein DI and dummy data are repeatedly recorded in the DI sector a predetermined number of times.

7. The method as set forth in claim 5, wherein the DI is recorded in first sectors of individual physical clusters.

8. The method as set forth in claim 1, wherein the DI is repeatedly recorded in a recording area corresponding to a reserved zone contained in the Lead-In zone of a BD-RE.

9. The method as set forth in one of claims 1, 2, 3 and 8, wherein the DI is repeatedly recorded in a plurality of layers.

10. A high-density recording medium, comprising: a Lead-In zone or a Lead-Out zone, wherein data is recorded in a recording unit, and
DI (Disc Information) in the form of pits, containing at least one of DT (Disc Type) information and DZA (Data Zone Allocation) information, is repeatedly recorded in the Lead-In zone or the Lead-Out zone.

11. The recording medium as set forth in claim 10, wherein the recording unit is the unit of a RUB (Recording Unit Block) corresponding to one ECC (Error Correction Code) block unit.

12. The recording medium as set forth in claim 10, wherein the Lead-In zone or the Lead-Out zone is comprised of a first area containing the DI and a second area separated from the first area,
wherein the second area also contains the repeatedly recorded DI.

13. The recording medium as set forth in claim 10, wherein the DI is repeatedly recorded in a recording area corresponding to a DMA (Defect Management Area) of a BD-RE (Blu-ray Disc Rewritable).

14. The recording medium as set forth in claim 13, wherein the DI is repeatedly recorded in physical sector units each having a predetermined length.

15. The recording medium as set forth in claim 14, wherein the DI is contained in a DI sector having a predetermined length, and is then recorded.

16. The recording medium as set forth in claim 15, wherein DI 112 bytes long and dummy data 144 bytes long are recorded in the DI sector a predetermined number of times.

17. The recording medium as set forth in claim 15, wherein the DI is recorded in first sectors of respective physical clusters.

18. The recording medium as set forth in claim 10, wherein the DI is repeatedly recorded in a recording area corresponding to a reserved zone contained in the Lead-In zone of a BD-RE.

19. The recording medium as set forth in one of claims 10, 12, 13 and 18, wherein the DI is repeatedly recorded in a plurality of layers.

20. A method for reproducing data recorded on a high-density read-only optical disc, comprising the steps of:
a) reading pit-shaped DI (Disc information) recorded on a Lead-In zone or a Lead-Out zone of the high-density read-only optical disc, while the DI including information required for reproducing data recorded on the high-density read-only optical disc; and
b) reproducing the data recorded on the high-density read-only optical disc based upon the read DI.

21. The method as set forth in claim 20, wherein DI includes at least one of DT (Disc Type) information and DZA (Data Zone Allocation) information.

22. The method as set forth in claim 20, wherein the Lead-In zone or the Lead-Out zone is comprised of a first area containing the DI and a second area separated from the first area,
wherein the DI in the form of pits is repeatedly recorded in the second area.

23. The method as set forth in claim 22, wherein the second area is a recording zone corresponding to a DMA (Defect Management Area) of a BD-RE (Blu-ray Disc Rewritable).

24. The method as set forth in claim 23, wherein the DI is repeatedly recorded in physical sector units each having a predetermined length.

25. The method as set forth in claim 22, wherein the second area is a recording zone corresponding to a reserved area contained in the Lead-In zone of a BD-RE.

26. The method as set forth in one of claims 20, 22, 23, and 25, wherein the DI is repeatedly recorded in a plurality of layers.

27. A method for recording information on a high-density read-only optical disc, comprising the step of:
a) repeatedly recording pit-shaped DI (Disc Information) associated with the high-density read-only optical disc in either a Lead-In zone or a Lead-Out zone; and,
b) recording the same DI in BCA.

28. A method for recording information on a high-density read-only optical disc, comprising the step of:
a) recording DI (Disc Information) associated with the high-density read-only optical disc in BCA; and,
b) repeatedly recording the same DI, in the form of pits, in either a Lead-In zone or a Lead-Out zone.

29. A high-density read-only optical disc, comprising:
a Lead-In zone or a Lead-Out zone,
wherein data is recorded in a recording unit,
DI (Disc Information), containing at least one of DT (Disc Type) information and DZA (Data Zone Allocation) information, is recorded in BCA which is located at inner area than the Lead-In zone, and
the same DI is repeatedly recorded, in the form of pits, in the Lead-In zone or the Lead-Out zone.
